(19) United States
(12) Patent Application Publication
(10) Pub. No.: US 2021/0076831 A1
(43) Pub. Date: Mar. 18, 2021

(54) Buoyant Pool Lounge Chair Frame and Buoyant Pool Lounge Chair Using the Same

(71) Applicant: TRC Recreation, LP, Wichita Falls, TX (US)

(72) Inventors: Matthew J. Iles, Graham, TX (US); Christopher B. Holland, Graham, TX (US); Michael V. Nelson, Wichita Falls, TX (US)

(21) Appl. No.: 16/692,044

(22) Filed: Nov. 22, 2019

Related U.S. Application Data
(60) Provisional application No. 62/902,114, filed on Sep. 18, 2019.

(51) Int. Cl. A47C 15/00; B63B 35/74; A47C 5/12

(52) U.S. Cl. CPC A47C 15/006; C08L 27/06; A47C 5/12; B63B 35/74

(57) ABSTRACT

A buoyant pool lounge chair frame and buoyant pool lounge chair using the same are disclosed. In one embodiment of the buoyant pool lounge chair for supporting a person while the buoyant pool lounge chair is floating in water, frame members collectively form at least one of a seat frame, a leg frame, a back frame, a left arm frame, and a right arm frame. The frame members include multiple frame segments which are steel coated with a first vinyl polymer coating to provide steel-to-vinyl contact. Buoyant cushions are attached to the frame members. The buoyant cushions are coated with a second vinyl polymer coating. An adhesive coating is interposed between the first vinyl polymer coating and the buoyant cushions.

### PRIORITY STATEMENT & CROSS-REFERENCE TO RELATED APPLICATIONS

This application claims priority from co-pending U.S. Patent Application No. 62/902,114, entitled “Buoyant Pool Lounge Chair Frame and Buoyant Pool Lounge Chair Using the Same” and filed on Sep. 18, 2019, in the names of Matthew J. Iles et al., which is hereby incorporated by reference for all purposes.

### TECHNICAL FIELD OF THE INVENTION

This invention relates, in general, to swimming pool accessories, and, in particular, to a buoyant pool lounge chair frame and a buoyant pool lounge chair utilizing the same for supporting a person in a seated position while the buoyant pool lounge chair frame is floating in water.

### BACKGROUND OF THE INVENTION

Swimming pools offer personal recreation and relaxation in a variety of settings, including private homes, apartment complexes, motels, resorts, and country clubs. Various flotation devices including buoyant chairs, rafts, water wings, floating cushions, body floats, and air mattresses are used by swimmers as an aid for floating and relaxing on the surface of the water, while remaining seated upright, reclining or lounging, either partially or completely submerged. These items of pool furniture include flotation cushions made of a buoyant material such as open cell foam, closed cell foam, cork, kapok, fiberglass or balsa wood, which are mounted to steel frames. Special care should be taken in the construction of buoyant lounge chairs to mitigate against rust as the buoyant lounge chairs are continuously in the presence of water and moisture during use. Rust negatively impacts the structural integrity of buoyant lounge chairs and may decrease the useful life of buoyant lounge chairs. As a result, there is a continuing need for improved design that mitigates against rust.

### SUMMARY OF THE INVENTION

It would be advantageous to achieve an encapsulated buoyant pool lounge chair frame and a buoyant pool lounge chair utilizing the same for providing support for a swimmer in an upright, semi-reclining or sitting position that would improve upon existing limitations in stability and functionality. It would also be desirable to enable a chemical and mechanical solution that satisfies comfort while mitigating against rust. To better address one or more of these concerns, an encapsulated buoyant pool lounge chair frame and a buoyant pool lounge chair utilizing the same are disclosed.

In one embodiment of the buoyant pool lounge chair for supporting a person while the buoyant pool lounge chair is floating in water, frame members collectively form at least one of a seat frame, a leg frame, a back frame, a left arm frame, and a right arm frame. The frame members include multiple frame segments which are steel coated with a first vinyl polymer coating to provide steel-to-vinyl contact. Buoyant cushions are attached to the frame members. The buoyant cushions are coated with a second vinyl polymer coating. An adhesive coating is interposed between the first vinyl polymer coating and the buoyant cushions. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a front perspective view of one embodiment of a buoyant pool lounge chair having an encapsulated buoyant pool lounge chair frame therein, according to the teachings presented herein;

FIG. 2 is a side perspective view of one embodiment of an encapsulated buoyant pool lounge chair frame according to the teachings presented herein; and

FIG. 3 is a process flow diagram depicting one embodiment of a set of interrelated methodologies for constructing the encapsulated buoyant pool lounge chair frame of FIG. 2 and the buoyant pool lounge chair of FIG. 1.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

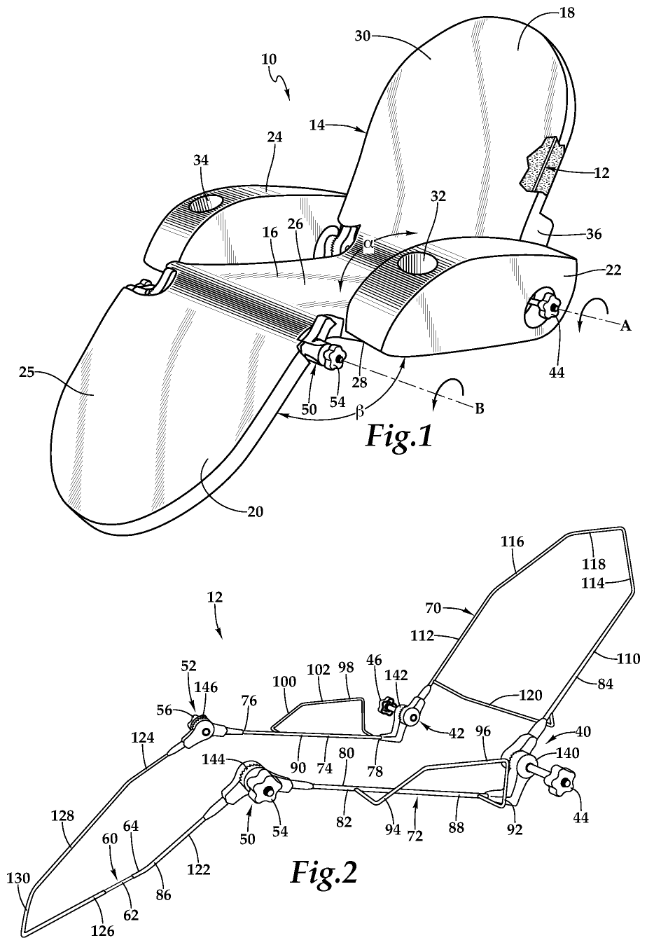

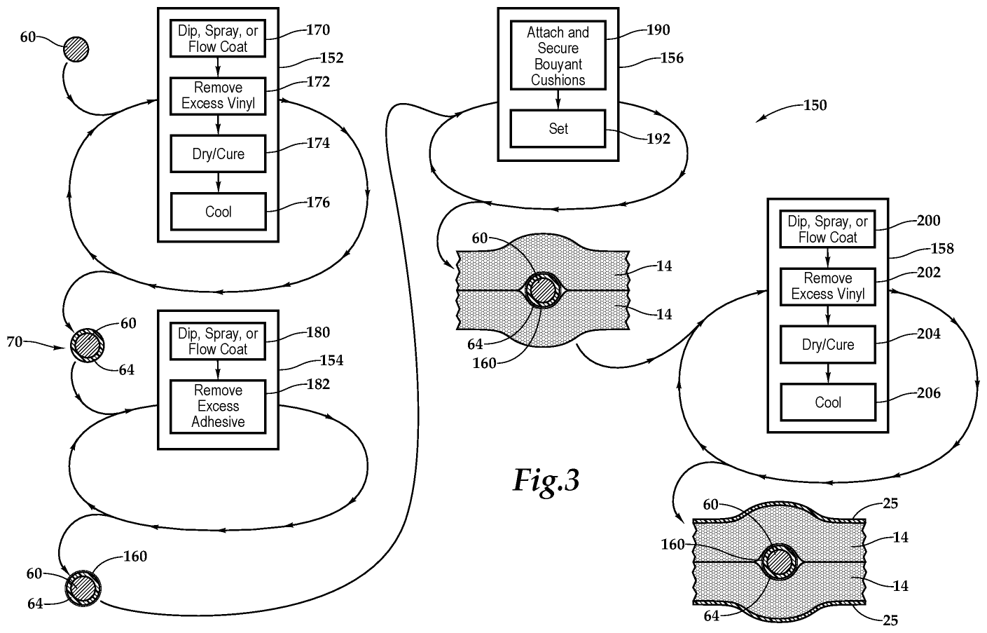

Referring now to FIG. 1 and FIG. 2, therein is depicted one embodiment of a buoyant pool lounge chair, which is schematically illustrated and designated 10. As will be discussed in detail hereinbelow, an encapsulated buoyant pool lounge chair frame 12 is located within the buoyant pool lounge chair 10. As shown, buoyant cushions 14 may be attached to the encapsulated buoyant pool lounge chair frame 12 such that the buoyant cushions 14 form a chair seat 16, a backrest 18, a leg rest 20, a left arm rest 22, and a right arm rest 24. As will be discussed in further detail hereinbelow, the buoyant cushions 14 may be coated with a vinyl polymer coating 25. The chair seat 16 includes a top side 26 and a bottom side 28. A head support cushion 30 may be secured to the back rest 18. Cup holders 32, 34 may be respectively located in the left arm rest 22 and the right arm rest 24. In one embodiment, a rear bolster cushion 36 extends from the rear of the backrest 18 to provide additional support and balance to the buoyant pool lounge chair 10.

In one embodiment, rear pivotal coupling and clutch assemblies 40, 42 are coupled to the encapsulated buoyant pool lounge chair frame 12. As shown, the rear pivotal coupling and clutch assemblies 40, 42 respectively include adjustment knobs 44, 46. By rotation of the adjustment knobs 44, 46 along mutual axis A, each of the pair of the rear pivotal coupling and clutch assemblies 40, 42 permit pivotal movement of the backrest 18 relative to the chair seat 16, and engageable to fix the angle of recline, a, of the backrest 18 relative to the chair seat 16. Similarly, in one embodiment, front pivotal coupling and clutch assemblies 50, 52 are coupled to the encapsulated buoyant pool lounge chair frame 12. As shown, the front pivotal coupling and clutch assemblies 50, 52 respectively include adjustment knobs 54, 56. By rotation of the adjustment knobs 54, 56 along mutual axis B, each of the pair of the front pivotal coupling and clutch assemblies 50, 52 permit pivotal movement of the leg rest 20 relative to the chair seat 16, and engageable to fix the angle of extension, β, of the leg rest 20 relative to the chair seat 16.

The pair of rear pivotal coupling and clutch assemblies 40, 42 permit pivotal movement of the backrest 18 relative to the chair seat 16 such that the backrest 18 is in proximate contact with the top side 26 of the chair seat 16. The pair of front pivotal coupling and clutch assemblies 50, 52 permit pivotal movement of the leg rest 20 relative to the chair seat 16 such that the leg rest 20 is in proximate contact with the bottom side 28 of the chair seat 16. In one implementation, the pair of rear pivotal coupling and clutch assemblies 40, 42 and the pair of front pivotal coupling and clutch assemblies 50, 52 cooperate in pivotal movement to provide a storage configuration wherein the backrest 18 is in proximate contact with the top side 26 of the chair seat 16 and the leg rest 20 is in proximate contact with the bottom side 28 of the chair seat 16.

In one embodiment, the buoyant pool lounge chair 10 may be relatively light weight for selectively supporting a person in seated, semi-reclining, and fully-reclining lounge positions while the buoyant pool lounge chair 10 is floating in water. As shown, the buoyant pool lounge chair 10 includes a chair seat 16, an adjustable backrest 18, an adjustable leg rest 20, left arm rest 22, and right arm rest 24, which provide full body support in the seated, upright, semi-reclining, and fully reclining lounge positions. The operative upright floating position refers to the flotation orientation of the buoyant pool lounge chair 10 with the adjustable backrest 18 and left and right arm rests 22, 24 generally upright while the chair seat 16 is generally horizontal and at least partially submerged. When the buoyant pool lounge chair 10 is floating in water, the occupant is supported in a comfortable lounging orientation with arms being supported by the left and right arm rests 22, 24 and head being supported by the head cushion 30 on the adjustable backrest 18. The occupant's legs are supported by the adjustable leg rest 20, which projects at varying angles forwardly from the chair seat 16. The adjustable backrest 18 and adjustable leg rest 20 provide for dual hinge adjustable reclining.

The encapsulated buoyant pool lounge chair frame 12 includes chair frame 60 having various frame segments 62. The frame segments 62 may be steel coated with a vinyl polymer coating 64 as discussed in more detail hereinbelow in order to provide steel-to-vinyl contact. More particularly, frame members 70, which are frame segments 62 encapsulated with the vinyl polymer coating 64, collectively form an open chair frame 72 including a seat frame 74 having a front end 76 and a rear end 78 and a top side 80 and a bottom side 82. A back frame 84 is pivotally coupled to the rear end 78 of the seat frame 74 and a leg frame 86 is pivotally coupled to the front end 76 of the seat frame 74. As shown, the seat frame 74 includes parallel seat support members 88, 90. A left arm frame 92 includes an arm support riser 94 that is laterally offset from the parallel seat support member 88 of the seat frame 74 and an arm rest segment 96 that is vertically offset from the seat frame 74. A right arm frame 98 includes an arm support riser 100 that is laterally offset from the parallel seat support member 90 of the seat frame 74 and an arm rest segment 102 that is vertically offset from the seat frame 74. As previously discussed, the buoyant cushions 14 are attached to the left arm frame 92 and the right arm frame 98 forming the left and right arms rests 22, 24.

In one embodiment, the back frame 84 may include back support members 110, 112 having respective back segments 114, 116 projecting therefrom and intersecting respective ends of a central back segment 118. A back cross member 120 extends from the back support member 110 to the back support member 112. The rear bolster cushion 36 may extend from the back cross member 120. Similarly, in one embodiment, the leg frame 86 may include leg support members 122, 124 having respective leg segments 126, 128 projecting therefrom and intersecting respective ends of a central leg segment 130. In one embodiment, a grommet (not shown) may be attached to the central leg segment 130.

The pair of rear pivotal coupling and clutch assemblies 40, 42 are coupled to the seat frame 74 and to the back frame 84 to permit pivotal movement of the back frame 84 relative to the seat frame 74, and engageable to fix the angle of recline, a, of the back frame 84 relative to the seat frame 74. The pair of front pivotal coupling and clutch assemblies 50, 52 are coupled to the leg frame 86 and to the seat frame 74 to permit pivotal movement of the leg frame 86 relative to the seat frame 74, and engageable to fix the angle of extension, β, of the leg frame 86 relative to the seat frame 74. The pair of rear pivotal coupling and clutch assemblies 40, 42 permit pivotal movement of the back frame 84 relative to the seat frame 74 such that the back frame 84 is in proximate contact with the top side 80 of the seat frame 74. The pair of front pivotal coupling and clutch assemblies 50, 52 permit pivotal movement of the leg frame 86 relative to the seat frame 74 such that the leg frame 86 is in proximate contact with the bottom side 82 of the seat frame 74. As shown best in FIG. 2, the pair of front pivotal coupling and clutch assemblies 50, 52 and the pair of rear pivotal coupling and clutch assemblies 40, 42 cooperate in pivotal movement to provide a storage configuration wherein the back frame 84 is in proximate contact with the top side 80 of the seat frame 74 and the leg frame 86 is in proximate contact with the bottom side 82 of the seat frame 74.

In one operational embodiment, with respect to the pair of front pivotal coupling and clutch assemblies 50, 52 and the pair of rear pivotal coupling and clutch assemblies 40, 42 in one embodiment, a pair of rear pivotal apparatus 140, 142 coupled to the seat frame 74 and to the back frame 84 may be utilized to permit closing rotational movement of the back frame 84 toward the top side 80 of the seat frame 74 to a folded position in which the back frame 84 extends proximate the top side 80 of the seat frame 74. Further, the pair of rear pivotal apparatus 140, 142 may permit opening rotational movement of the back frame 84 away from the top side 80 of the seat frame 74 to an upright position in which the back frame 84 projects transversely to the seat frame 74. With respect to the leg rest 20 and leg frame 86, a pair of front pivotal apparatus 144, 146 coupled to the seat frame 74 and to the leg frame 86 may be utilized to permit closing rotational movement of the leg frame 86 toward the bottom side 82 of the seat frame 74 to a folded position in which the leg frame 86 extends proximate the bottom side 82 of the seat frame 74. Moreover, the pair of front pivotal apparatus 144, 146 may permit opening rotational movement of the leg frame 86 away from the bottom side 82 of the seat frame 74 to an extended position in which the leg frame 86 projects forward from the seat frame 74. In some embodiments, the pair of rear pivotal apparatus 140, 142 and the pair of front pivotal apparatus 144, 146 cooperate in rotational movement to provide a storage configuration wherein the back frame 84 is in proximate contact with the top side 80 of the seat frame 74 and the leg frame 86 is in proximate contact with the bottom side 82 of the seat frame 74.

It should be appreciated that although a particular design of a buoyant pool lounge chair 10 is depicted in FIGS. 1 and 2, other designs of buoyant pool lounge chairs are within the teachings presented herein. The buoyant pool lounge chair 10 for supporting a person while the buoyant pool lounge chair 10 is floating in water may include frame members forming at least one of a seat frame, a leg frame, a back frame, a left arm frame, and a right arm frame. The frame members may include multiple frame segments with the frame segments being steel coated with a vinyl polymer coating as discussed in more detail hereinbelow in order to provide steel-to-vinyl contact. Buoyant cushions may be attached to the encapsulated frame members. Further, the buoyant cushions may be coated with a vinyl polymer coating. As will be discussed in additional detail hereinbelow, an adhesive coating may be interposed between the vinyl polymer coating and the buoyant cushions.

Similarly, it should be appreciated that although a particular design of an encapsulated buoyant pool lounge chair frame 12 is depicted in FIGS. 1 and 2, other designs of encapsulated buoyant pool lounge chair frames are within the teachings presented herein. By way of example and not by way of limitation, the encapsulated buoyant pool lounge chair frame for a buoyant pool lounge chair that supports a person while the buoyant pool lounge chair is floating in water may include frame members collectively forming at least one of a seat frame, a leg frame, a back frame, a left arm frame, and a right arm frame. The frame members include the frame segments, which may be steel coated with a vinyl polymer coating to provide steel-to-vinyl contact.

Referring now to FIG. 3, a process flow diagram is shown that depicts one embodiment of a process 150 having a set of interrelated methodologies for constructing the encapsulated buoyant pool lounge chair frame 12 and the buoyant pool lounge chair 10. Within the discussion of FIG. 3, the present invention will now be illustrated by reference to the following non-limiting working examples wherein procedures and materials are solely representative of those which can be employed and are not exhaustive of those available and operative. The following glossary enumerates the components utilized in the process flow presented hereinbelow.

ADHESIVE COATING is any substance, inorganic or organic, natural or synthetic, that is capable of bonding other substances together by surface attachment.

CLOSED CELL POLYURETHANE FOAM is a polyurethane foam with cells pressed together, so air and moisture are less likely to penetrate the polyurethane foam.

ELASTOMERIC SEALANT is a substance that is soft enough to pour or extrude, for example, and is capable of subsequent hardening to form a permanent bond with the substrate or substrates. The substance includes synthetic thermosetting high polymers having properties similar to vulcanized natural rubber.

ETHYLENE PROPYLENE DIENE TERPOLYMER is an extremely durable synthetic rubber membrane material having primary ingredients of ethylene and propylene.

NEOPRENE is a synthetic polychloroprene elastomer.

NITRILE is an organic compound containing the —CN grouping.

POLYURETHANE FOAM is a thermoplastic polymer produced by the condensation reaction of a polyisocyanate and hydroxyl-containing material, e.g., a polyol derived from propylene oxide or trichlorobutylene oxide.

POLYVINYL CHLORIDE LIQUID VINYL COATING is a synthetic thermoplastic polymer with the formula (—H₂CCHCl—)ₙ.

STEEL is an alloy of iron and carbon.

STYRENE-BUTADIENE ELASTOMER is an elastomer that requires no vulcanization, while displaying most of the properties of conventional vulcanized polymers.

URETHANE is ethyl carbamate.

VINYL POLYMER COATING is a coating including a compound having the vinyl grouping (CH₂═CH—), specifically vinyl chloride, vinyl acetate, and similar esters.

In the non-limiting embodiment of FIG. 3, the process 150 includes a single integrated processing line that contains multiple stations 152, 154, 156, 158 wherein each station interacts with an article received as an input to produce an article which is the output. As illustrated, each of the multiple stations 152, 154, 156, 158 may be modular wherein each of the multiple stations 152, 154, 156, 158 is self-contained with the ability to allow for single or multiple interactions. This allows for single or multiple coatings, for example, and provides for maximum flexibility. The multiple stations 152, 154, 156, 158 may also allow handoff to another station to advance the article through the process 150.

In the illustrated embodiment, at the station 152, the chair frame 60 enters the station 152. As previously discussed, the chair frame 60 may be steel. At the station 152, the chair frame 60 is initially dipped, sprayed, or flow coated with a vinyl polymer coating 64 at process block 170. In one embodiment, the vinyl polymer coating 64 is a polyvinyl chloride liquid vinyl coating and the chair frame 60 is dipped into the polyvinyl chloride liquid vinyl coating. At process block 172, any excess vinyl polymer coating 64 is removed from the chair frame 60. At process block 174, the vinyl polymer coating 64 is dried and cured prior to the vinyl polymer coating 64 cooling at process block 176. The chair frame 60 with the vinyl polymer coating 64 may exit the station 152 or stay at the station 152 for an application of another coat of the vinyl polymer coating 64. Once the chair frame 60 with the vinyl polymer coating 64 exits station 152, the chair frame 60 with the vinyl polymer coating 64 enters the station 154.

At the station 154, the chair frame 60 with the vinyl polymer coating 64 is dipped, sprayed, or flow coated with an adhesive coating 160 at process block 180. In one embodiment, the adhesive coating 160 is an elastomeric sealant. Elastomeric sealants with a base chemistry of one or more of neoprene, ethylene propylene diene terpolymer, nitrile, urethane, and a styrene-butadiene elastomer have particular efficacy in some operational embodiments. At process block 182, any excess adhesive coating 160 is removed from the vinyl polymer coating 64 on the chair frame 60. The chair frame 60 with the vinyl polymer coating 64 and the adhesive coating 160 may exit the station 154 or stay at the station 154 for an application of another coat of the adhesive coating 160. Once the chair frame 60 with the vinyl polymer coating 64 and the adhesive coating 160 exits station 154, the chair frame 60 with the vinyl polymer coating 64 and the adhesive coating 160 enters the station 156.

At the station 156, as shown at process block 190, the buoyant cushions 14 are attached and secured to the chair frame 60 with the vinyl polymer coating 64 utilizing the adhesive coating 160 which forms a strong bond between the vinyl polymer coating 64 and the buoyant cushions 14. In one embodiment, the buoyant cushions 14 include a polyurethane foam. Closed cell polyurethane foams have demonstrated efficacy in some operational embodiments. At process block 192, the buoyant cushions 14 are set. The chair frame 60 with the vinyl polymer coating 64 and the adhesive coating 160 may exit the station 156 once all of the buoyant cushions 14 are set or stay at the station 156 for additional buoyant cushions 14 to be attached, secured, and set. Once the chair frame 60 with the vinyl polymer coating 64 and the adhesive coating 160 exits station 156 with all the buoyant cushions 14, the article enters the station 158.

As shown, at the station 158, the chair frame 60 enters the station 158. At the station 158, the chair frame 60 having the vinyl polymer coating 64 with the buoyant cushions 14 secured by an adhesive coating 160 is dipped, sprayed, or flow coated with a vinyl polymer coating 25 at process block 200. In one embodiment, the vinyl polymer coating 25 is a polyvinyl chloride liquid vinyl coating and the chair frame 60 having the vinyl polymer coating 64 with the buoyant cushions 14 secured by an adhesive coating 160 is flow coated with the polyvinyl chloride liquid vinyl coating. In one embedment, the vinyl polymer coating 25 and the vinyl polymer coating 64 are the same type of vinyl polymer coating. At process block 202, any excess vinyl polymer coating 25 is removed from the article. At process block 204, the vinyl polymer coating 25 is dried and cured prior to the vinyl polymer coating 25 cooling at process block 206. The chair frame 60 having the vinyl polymer coating 64 with the buoyant cushions 14 secured by an adhesive coating 160 and the outer layer of the vinyl polymer coating 25 may exit the station 158 or stay at the station 158 for an application of another coat of the vinyl polymer coating 25.

As constructed, in one embodiment, the buoyant pool lounge chair 10 may be designed as a continuous form of pliable foam material of constant or appropriately varying density that varies in thickness to provide the buoyant cushions 14 having the protective vinyl polymer coating 25 thereon. The construction may include molded foam being provided by a single molding process and may include void spaces of select shapes to accommodate the cup holders or various components of the frame members, for example. In one embodiment, the construction includes slabs of closed cell polyurethane foam having a density in the range of approximately 1 lbs/ft³ (16 kg/m³) to approximately 6 lbs/ft³ (96 kg/m³). In one embodiment, any required frame members may be constructed of the aforementioned steel, e.g., steel rod segments that are welded together, or polyvinyl chloride (PVC) material. In another embodiment, multiple closed-cell PVC boards may be sandwiched between foam slabs to increase the rigidity of components such as the chair seat, left arm rest, left arm rest, backrest, and leg rest. Further, the frame members may be made by a partially or fully blown molded process depending on volumes. It should be appreciated that although a particular construction and materials are presented herein, the construction of the buoyant pool lounge chair 10 and encapsulated buoyant pool lounge chair frame 12 presented herein may vary according to the particular application and other constructions and choices of materials within the teachings presented herein.

As previously alluded, special care should be taken in the consideration of buoyant lounge chairs to provide sufficient buoyancy material to maintain a stable upright orientation while the occupant is in a semi-reclining orientation following, in the present application, the engagement of the flotation device with the encapsulated buoyant pool lounge chair frame 12 to provide the buoyant pool lounge chair 10. Such special care is warranted as any buoyant lounge chair can overturn in response to shifting of its center of buoyancy as the occupant turns or moves about. In one embodiment of the buoyant pool lounge chair 10 and the encapsulated buoyant pool lounge chair frame 12, buoyancy sufficient to support an adult occupant having a body weight of 250 lbs (113 kg) is provided by the construction.

The order of execution or performance of the methods and operations illustrated and described herein is not essential, unless otherwise specified. That is, elements of the methods and flows may be performed in any order, unless otherwise specified, and that the methods may include more or less elements than those disclosed herein. For example, it is contemplated that executing or performing a particular step before, contemporaneously with, or after another step are all possible sequences of execution.

While this invention has been described with reference to illustrative embodiments, this description is not intended to be construed in a limiting sense. Various modifications and combinations of the illustrative embodiments as well as other embodiments of the invention will be apparent to persons skilled in the art upon reference to the description. It is, therefore, intended that the appended claims encompass any such modifications or embodiments.

What is claimed is:

1. A buoyant pool lounge chair for supporting a person while the buoyant pool lounge chair is floating in water, comprising:
frame members collectively forming an open chair frame, the frame members including a seat frame having a front end and a rear end, the seat frame having a top side and a bottom side;
the seat frame including a seat support member, the seat support member being steel coated with a first vinyl polymer coating to provide steel-to-vinyl contact;
buoyant cushions attached to the seat support member, the buoyant cushions forming a chair seat, the buoyant cushions being coated with a second vinyl polymer coating; and
an adhesive coating interposed between the first vinyl polymer coating and the buoyant cushions.

2. The buoyant pool lounge chair as recited in claim 1, wherein the first vinyl polymer coating and the second vinyl polymer coating further comprise the same material.

3. The buoyant pool lounge chair as recited in claim 1, wherein the first vinyl polymer coating further comprises a polyvinyl chloride liquid vinyl coating.

4. The buoyant pool lounge chair as recited in claim 1, wherein the second vinyl polymer coating further comprises a polyvinyl chloride liquid vinyl coating.

5. The buoyant pool lounge chair as recited in claim 1, wherein the first vinyl polymer coating is applied to the seat support member by a technique selected from the group consisting of dipping, spraying, and coating.

6. The buoyant pool lounge chair as recited in claim 1, wherein the second vinyl polymer coating is applied to the seat support member by a technique selected from the group consisting of dipping, spraying, and coating.

7. The buoyant pool lounge chair as recited in claim 1, wherein the adhesive coating further comprises an elastomeric sealant.

8. The buoyant pool lounge chair as recited in claim 1, wherein the buoyant cushions further comprise polyurethane foam.

9. The buoyant pool lounge chair as recited in claim 1, wherein the buoyant cushions further comprise closed cell polyurethane foam.

10. The buoyant pool lounge chair as recited in claim 1, further comprising:
a left arm frame coupled to the seat frame;
a right arm frame coupled to the seat frame;
each of the left arm frame and the right arm frame including respective frame segments, the frame segments being coated with the first vinyl polymer coating to provide steel-to-vinyl contact;
buoyant cushions attached to the frame segments, the buoyant cushions forming respective left and right arm rests, the buoyant cushions being coated with the second vinyl polymer coating; and
an adhesive coating interposed between the first vinyl polymer coating and the buoyant cushions.

11. The buoyant pool lounge chair as recited in claim 10, wherein the frame segment of the left arm frame further comprises an arm support riser that is laterally offset from the seat frame and an arm rest segment that is vertically offset from the seat frame; and
the frame segment of the right arm frame further comprises an arm support riser that is laterally offset from the seat frame and an arm rest segment that is vertically offset from the seat frame.

12. The buoyant pool lounge chair as recited in claim 1, wherein the seat frame further comprises first and second parallel seat support members.

13. The buoyant pool lounge chair as recited in claim 1, further comprising:
a back frame coupled to the rear end of the seat frame;
the back frame including a plurality of frame segments, the plurality of frame segments being coated with the first vinyl polymer coating to provide steel-to-vinyl contact;
buoyant cushions attached to the plurality of frame segments, the buoyant cushions forming a backrest, the buoyant cushions being coated with the second vinyl polymer coating; and
an adhesive coating interposed between the first vinyl polymer coating and the buoyant cushions.

14. The buoyant pool lounge chair as recited in claim 13, wherein the plurality of frame segments further comprises:
first and second back support members having respective first and second back segments projecting therefrom and intersecting respective ends of a central back segment; and
a back cross member extending from the first back support member to the vertical back support member.

15. The buoyant pool lounge chair as recited in claim 13, wherein a pair of rear pivotal coupling and clutch assemblies permit pivotal movement of the back frame relative to the seat frame.

16. The buoyant pool lounge chair as recited in claim 1, further comprising:
a leg frame coupled to the front end of the seat frame;
the leg frame including a plurality of frame segments, the plurality of frame segments being coated with the first vinyl polymer coating to provide steel-to-vinyl contact;
buoyant cushions attached to the plurality of frame segments, the buoyant cushions forming a leg rest, the buoyant cushions being coated with the second vinyl polymer coating; and
an adhesive coating interposed between the first vinyl polymer coating and the buoyant cushions.

17. The buoyant pool lounge chair as recited in claim 16, wherein the plurality of frame segments of the leg frame further comprises first and second leg support members having respective first and second leg segments projecting therefrom and intersecting respective ends of a central leg segment.

18. The buoyant pool lounge chair as recited in claim 16, wherein a pair of front pivotal coupling and clutch assemblies permit pivotal movement of the leg frame relative to the seat frame.

19. A buoyant pool lounge chair for supporting a person while the buoyant pool lounge chair is floating in water, comprising:
frame members forming at least one of a seat frame, a leg frame, a back frame, a left arm frame, and a right arm frame;
the frame members including a plurality of frame segments, the plurality of frame segments being steel coated with a first vinyl polymer coating to provide steel-to-vinyl contact;
buoyant cushions attached to the plurality of frame members, the buoyant cushions being coated with a second vinyl polymer coating; and
an adhesive coating interposed between the first vinyl polymer coating and the buoyant cushions.

20. A buoyant pool lounge chair frame for a buoyant pool lounge chair that supports a person while the buoyant pool lounge chair is floating in water, the buoyant pool lounge chair comprising:
frame members collectively forming an open chair frame, the frame members including at least one of a seat frame, a leg frame, a back frame, a left arm frame, and a right arm frame; and
the frame members including a plurality of frame segments, the plurality of frame segments being steel coated with a vinyl polymer coating to provide steel-to-vinyl contact.
